(19) United States
(12) Patent Application Publication
(10) Pub. No.: US 2026/0118183 A1
(43) Pub. Date: Apr. 30, 2026

(54) CALIBRATION FIXTURE FOR THERMAL IMAGING SENSORS

(71) Applicant: Seek Thermal, Inc., Goleta, CA (US)

(72) Inventors: Matt Buckley, Santa Barbara, CA (US); Andrew Duerner, Santa Barbara, CA (US); Jack Wiest, Santa Barbara, CA (US); William J. Parrish, Santa Barbara, CA (US); Daniel Bode, Santa Barbara, CA (US)

(21) Appl. No.: 19/373,501

(22) Filed: Oct. 29, 2025

Related U.S. Application Data
(60) Provisional application No. 63/714,653, filed on Oct. 31, 2024.

(51) Int. Cl. G01J 5/80; G01J 5/00; G01J 5/0806

(52) U.S. Cl. CPC G01J 5/80; G01J 5/0806; G01J 2005/0077

(57) ABSTRACT

The current disclosure provides fixtures for calibrating thermal imaging sensors. It can include two or more temperature control devices: one for controlling the ambient temperature of the sensor and one that controls the temperature of a blackbody scene. The fixture can also include a reflective element that can be configured such that in one configuration the sensor views the blackbody and in another views itself. By keeping the blackbody and the sensor ambient temperature different, this arrangement allows for rapid viewing of two scene temperatures for each time the temperatures of the sensor and blackbody are slewed. This design simplifies the calibration process, reduces test time, and reduces costs.

### CROSS-REFERENCE TO RELATED APPLICATIONS

This application claims the benefit of U.S. Provisional Application Ser. No. 63/714,653, filed Oct. 31, 2024, titled CALIBRATION FIXTURE FOR THERMAL IMAGING SENSORS, which is incorporated by reference herein in its entirety.

### FIELD

The present application relates to thermal imaging sensors and to devices and methods for calibration thereof.

### BACKGROUND

Thermal imaging sensors require precise calibration to ensure image uniformity and accurate temperature resolution, usually requiring that multiple different scene temperatures are imaged at multiple different sensor ambient temperatures. Existing calibration fixtures are often complex, time-consuming to use, and costly to produce. The current disclosure addresses these issues by providing a small, fast, and inexpensive calibration fixture, including a novel implementation of a reflective element.

### SUMMARY

The following presents a simplified summary of the disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the description below.

The current disclosure provides fixtures for calibrating thermal imaging sensors. The fixture may include two or more temperature control devices: one for controlling the ambient temperature of the sensor and one that controls the temperature of at least one blackbody scene. The fixture may also include a movable or variable reflective element such as a mirror that can be configured such that in one configuration the sensor views the blackbody and in the other configuration the sensor views itself. By keeping the blackbody and the sensor ambient temperature different, this arrangement allows for rapid viewing of two scene temperatures. This design may simplify the calibration process, reduce test time, and/or reduce costs associated with calibration of thermal imaging sensors. The fixture may interface to and be controlled by a controller which may be a digital processor of a variety of types.

In some embodiments of the first aspect, the fixture comprises a sensor mount, a mirror assembly or movable or variable transmission reflective element, and at least two temperature-controlled mechanisms: one for controlling the ambient temperature of the sensor and its mounting elements, and one for controlling the temperature of at least one blackbody scene. If the reflective element is a mirror, the mirror assembly may be pivotable to flip the mirror between two positions. In the first position, the reflective element reflects the image of the sensor and sensor mounting elements back onto the sensor. In the second position, the reflective element is removed from the field of view of the sensor and exposes the sensor to the blackbody scene.

In some embodiments, the temperature controllers can be TEC devices or other suitable controllers. In one embodiment, the reflective element is a variable transmission device wherein the element is removed from the sensor field of view by increasing the transmission of the element. In a further embodiment, the reflective element is a movable mirror that is movable in and out of the sensor field of view.

In some embodiments, the mirror is mounted on a pivoting arm or similar mechanism. An actuator or manual control flips the mirror between the two positions. The mirror's position is stable and repeatable to ensure consistent calibration results. In one embodiment, the components are disposed in a chamber which is openable or separable to allow for installation of the sensor under test. The chamber may be optionally insulated, dry purged, and/or temperature controlled.

In some embodiments, the sensor is mounted in the fixture, aligned with the mirror. The fixture can be controlled to set the ambient temperature of the sensor and the at least one blackbody scene to desired reference temperatures. The mirror can be flipped to alternate between the blackbody and reflection of itself at the two temperatures, allowing the sensor to capture images of both. The blackbody and the sensor mount are set to as many different temperatures as desired. More than one blackbody and associated mirror positions may be employed. The captured images at the various scene and ambient temperatures can be used to calibrate the sensor for uniformity and temperature accuracy.

In another aspect, a fixture for calibrating thermal imaging sensors includes a sensor mount configured to be in thermal contact with a sensor, at least one blackbody scene element, a movable or variable transmission reflective element, at least two temperature controllers, and an actuator or manual control configured to selectively place the reflective element in one of at least two configurations. The at least two temperature controllers include a first temperature controller configured to control a temperature of the sensor mount and a second temperature controller configured to control a temperature of the blackbody scene element. In a first one of the at least two configurations, the movable or variable transmission reflective element exposes the sensor to the at least one blackbody scene element, and in a second one of the at least two configurations, the movable or variable transmission reflective element reflects images of the sensor mount or the sensor back to the sensor.

In some embodiments, the first temperature controller and the second temperature controller include thermoelectric controller (TEC) devices. In some embodiments, the fixture further includes a first heatsink coupled to the first temperature controller and a second heatsink coupled to the second temperature controller.

In some embodiments, the at least one blackbody scene element includes a thermal uniformity plate.

In some embodiments, the sensor mount comprises a thermal uniformity plate configured to be removably coupled to the sensor.

In some embodiments, the movable or variable transmission reflective element includes a variable transmission device, wherein the movable or variable transmission reflective element transitions from the second one of the at least two configurations to the first one of the at least two configurations by increasing the transmission of the element. In some embodiments, the movable or variable transmission reflective element transitions from the first one of the at least two configurations to the second one of the at least two configurations by decreasing the transmission of the element.

In some embodiments, the movable or variable transmission reflective element includes a movable mirror that is movable in and out of a field of view of the sensor. In some embodiments, the mirror's position is stable and repeatable. In some embodiments, in the first one of the at least two configurations, the mirror is positioned outside the field of view of the sensor;

and in the second one of the at least two configurations, the mirror is positioned at least partially within the field of view of the sensor.

In some embodiments, at least a portion of the fixture is disposed in a chamber which is openable or separable to allow for installation of the sensor under test. In some embodiments, the chamber includes an insulated enclosure. In some embodiments, the chamber comprises a dry purged enclosure. In some embodiments, the chamber comprises a temperature controlled enclosure.

### BRIEF DESCRIPTION OF THE DRAWINGS

The novel features of the various embodiments of the current disclosure are set forth with particularity in the appended claims. A better understanding of the features and advantages of the various embodiments of the present disclosure will be obtained by reference to the following detailed description that sets forth illustrative embodiments, in which the principles of the disclosure are utilized, and the accompanying drawings of which:

FIG. 1 schematically illustrates an example calibration fixture in accordance with the present disclosure.

FIG. 2 is schematically illustrates an example embodiment of a calibration fixture in accordance with the present disclosure.

### DETAILED DESCRIPTION

Generally described, the current disclosure provides fixtures for calibrating thermal imaging sensors which may include two or more temperature control devices. A first temperature control device can control the ambient temperature of the sensor and a second temperature control device can control the temperature of at least one blackbody scene to be presented to the thermal imaging sensor during calibration. The fixture may also include a movable or variable reflective element such as a mirror that can be configured such that in one configuration the sensor views the blackbody and in the other configuration the sensor views itself. By keeping the blackbody and the sensor ambient temperature different, this arrangement allows for rapid viewing of two scene temperatures. This design may simplify the calibration process, reduce test time, and/or reduce costs associated with calibration of thermal imaging sensors. The fixture may interface to and be controlled by a controller which may be a digital processor of a variety of types.

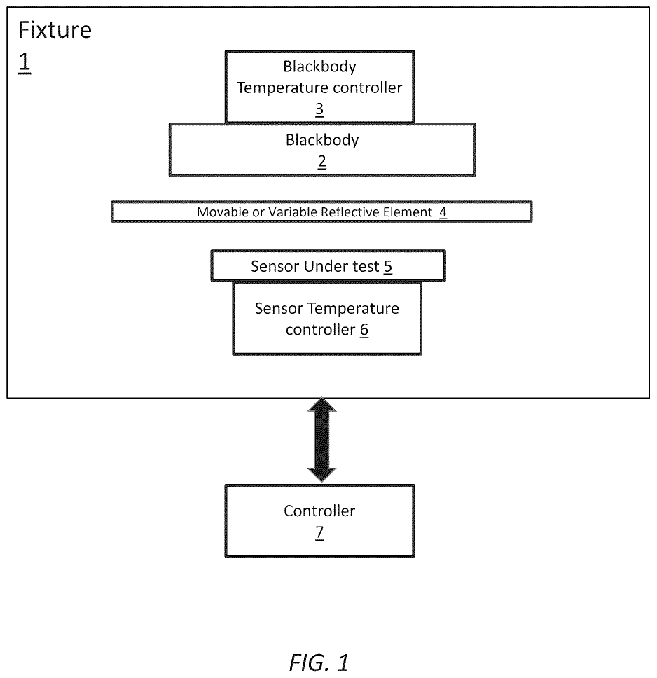

FIG. 1 schematically illustrates a general configuration of a calibration fixture 1 interfaced to a controller 7. As shown in FIG. 1, the fixture 1 is configured to hold a sensor under test 5 and can include a movable or variable reflective element 4 which may be a mirror assembly, and at least two temperature-controlled mechanisms. A sensor temperature controller 6 is disposed near the sensor under test 5 for controlling the ambient temperature of the sensor under test 5 and its mounting elements. In some embodiments, the sensor temperature controller 6 can include or be integrated within a mount for the sensor under test 5. A blackbody temperature controller 3 is disposed near a blackbody 2 and is configured to control the temperature of the blackbody 2 such that the blackbody 2 provides a blackbody scene that is selectively exposable to the sensor under test 5.

It is possible to have more than one blackbody in the calibration fixture 1. For example, in embodiments including more than one blackbody, any suitable mechanism may be employed to selectively bring the individual blackbodies 2 into view of the sensor.

The movable or variable reflective element 4 may be a variable transmission device whose reflection/transmission may be controlled by the controller to either reflect back onto the sensor or expose the sensor to a blackbody. In other example embodiments, the movable or variable reflective element 4 may be connected to a mechanical actuator configured to move the movable or variable reflective element 4 into and out of the field of view of the sensor under test 5. It is understood that the fixture may be interfaced to a controller 7 and the various fixture elements may be configured for electronic or optionally in some cases manual control. Such control features may include a variety of digital electronic, mechanically actuated, and others, not described in detail herein.

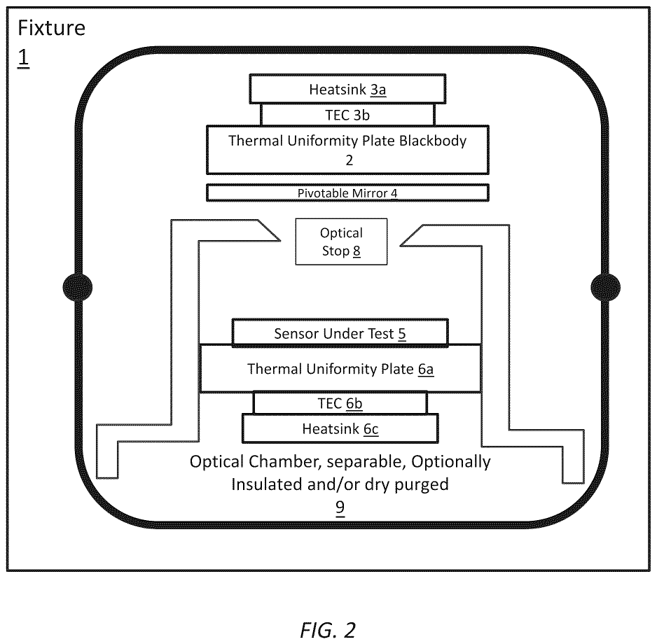

A more detailed non-limiting example embodiment of a calibration fixture in accordance with the present disclosure is shown in FIG. 2. In this particular example, the movable or variable reflective element 4 is a pivotable mirror. The pivotable mirror can be a part of a mirror assembly which can include a pivot mechanism to flip the mirror between two positions.

In the first position, the movable or variable reflective element 4 reflects the image of the sensor under test 5 and part of the sensor mounting temperature control elements back onto the sensor under test 5. In this embodiment, the exemplary sensor temperature control elements can include a thermal uniformity plate 6a, for example, a metal plate, a thermoelectric controller (TEC) 6b, and a heatsink 6c. In the second position, the mirror 4 is removed from the field of view of the sensor and exposes the sensor 5 to the at least one blackbody 2. In this embodiment, the exemplary blackbody 2 comprises a thermal uniformity plate. The exemplary blackbody temperature control elements can similarly include a thermoelectric controller (TEC) 3b and a heatsink 3a.

The exemplary blackbody temperature controllers are shown as TEC devices and a heatsink, but other suitable controllers are possible for temperature control of both the sensor under test 5 and the blackbody 2. The blackbody 2 and the sensor under test 5 are positioned such that the mirror can alternately reflect their images into the sensor's field of view.

The mirror can be mounted on a pivoting arm or similar mechanism. An actuator or manual control can flip the mirror between the two positions. The mirror's position is stable and repeatable to ensure consistent calibration results.

The sensor under test 5 can be mounted in the fixture aligned with the mirror and optical baffling or stop elements such as optical stop 8 may be built into the fixture 1.

The fixture 1 may be built as an openable or separable chamber 9, allowing for placing the sensor under test 5 into the chamber 9 and when closed providing optical and environmental isolation during operation. The chamber 9 may optionally be insulated for sound and/or temperature, dry purged, and/or the internal temperature of the entire chamber 9 may be controlled.

The mirror 4 is flipped to alternate between the blackbody and reflection of itself at the two temperatures, allowing the sensor to capture images of both. The blackbody and the sensor mount are set to as many different temperatures as desired. The captured images at the various scene and ambient temperatures are used to calibrate the sensor for uniformity and temperature accuracy.

It is to be understood that both the foregoing general description and the following detailed description are exemplary and explanatory only and are not restrictive of the present technology as claimed. In the detailed description of the various embodiments of the present disclosure, specific exemplary embodiments in which the principles of the present disclosure are utilized are shown and described. As described, these exemplary embodiments are only illustrative of the various ways in which the principles of the present disclosure may be utilized, and the present disclosure is intended to include all such embodiments and their equivalents.

Throughout the disclosure, the term “exemplary” is used to mean “serving as an example, instance, or illustration.” Any aspect or design described herein as “exemplary” is not necessarily to be construed as preferred or advantageous over other aspects or designs. The use of the term “exemplary” throughout this disclosure is intended to provide examples of the present disclosure and does not mean to imply a preference unless otherwise stated.

As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Other combinations and/or modifications of the structures, arrangements, applications, proportions, elements, materials, or components used in the practice of the present disclosure, in addition to those not specifically recited, may be varied or otherwise particularly adapted to specific environments and operative requirements without departing from the general principles of the same.

What is claimed is:

1. A fixture for calibrating thermal imaging sensors, the fixture comprising:
a sensor mount configured to be in thermal contact with a sensor;
at least one blackbody scene element;
a movable or variable transmission reflective element;
at least two temperature controllers comprising:
a first temperature controller configured to control a temperature of the sensor mount; and
a second temperature controller configured to control a temperature of the blackbody scene element; and
an actuator or manual control configured to selectively place the reflective element in one of at least two configurations;
wherein:
in a first one of the at least two configurations, the movable or variable transmission reflective element exposes the sensor to the at least one blackbody scene element, and
in a second one of the at least two configurations, the movable or variable transmission reflective element reflects images of the sensor mount or the sensor back to the sensor.

2. The fixture of claim 1, wherein the first temperature controller and the second temperature controller comprise thermoelectric controller (TEC) devices.

3. The fixture of claim 2, further comprising a first heatsink coupled to the first temperature controller and a second heatsink coupled to the second temperature controller.

4. The fixture of claim 1, wherein the at least one blackbody scene element comprises a thermal uniformity plate.

5. The fixture of claim 1, wherein the sensor mount comprises a thermal uniformity plate configured to be removably coupled to the sensor.

6. The fixture of claim 1, wherein the movable or variable transmission reflective element comprises a variable transmission device, wherein the movable or variable transmission reflective element transitions from the second one of the at least two configurations to the first one of the at least two configurations by increasing the transmission of the element.

7. The fixture of claim 6, wherein the movable or variable transmission reflective element transitions from the first one of the at least two configurations to the second one of the at least two configurations by decreasing the transmission of the element.

8. The fixture of claim 1, wherein the movable or variable transmission reflective element comprises a movable mirror that is movable in and out of a field of view of the sensor.

9. The fixture of claim 8, wherein the mirror's position is stable and repeatable.

10. The fixture of claim 8, wherein:
in the first one of the at least two configurations, the mirror is positioned outside the field of view of the sensor; and
in the second one of the at least two configurations, the mirror is positioned at least partially within the field of view of the sensor.

11. The fixture of claim 1, wherein at least a portion of the fixture is disposed in a chamber which is openable or separable to allow for installation of the sensor under test.

12. The fixture of claim 6, wherein the chamber comprises an insulated enclosure.

13. The fixture of claim 6, wherein the chamber comprises a dry purged enclosure.

14. The fixture of claim 6, wherein the chamber comprises a temperature controlled enclosure.
